(19) United States
(12) Patent Application Publication
(10) Pub. No.: US 2026/0078275 A1
(43) Pub. Date: Mar. 19, 2026

(54) COMPOSITIONS AND METHODS FOR REINFORCING SUBSTRATES

(71) Applicant: American Polymers Corp., Santa Fe Springs, CA (US)

(72) Inventors: Niteen Jadhav, Santa Fe Springs, CA (US); Vipul Mistry, Santa Fe Springs, CA (US); Rohan Gupta, Santa Fe Springs, CA (US); Thomas Choe, Santa Fe Springs, CA (US)

(21) Appl. No.: 19/319,373

(22) Filed: Sep. 4, 2025

Related U.S. Application Data
(60) Provisional application No. 63/696,093, filed on Sep. 18, 2024.

(51) Int. Cl. C09D 163/10; C08G 59/40; C08J 9/32

(52) U.S. Cl. CPC C09D 163/10; C08G 59/4021; C08J 9/32; C08J 2203/22

(57) ABSTRACT

Compositions for reinforcing substrates, reinforced panels manufactured from those compositions, and methods of manufacture are disclosed. A composition may be composed of a base resin binder, a reinforcing fiber, a toughener, a heat curing agent, a cure accelerating agent, a sagging resistance agent, and a reinforcing agent. A coating of this composition can be applied upon a substrate, such as a steel or aluminum substrate. By heating the coating such that the coating cures upon the substrate, a reinforced substrate may be produced. The substrate may be sized and configured as a panel so that it could be used as an automotive panel. The low density and strong characteristics of the cured coating may allow for thin, lightweight automotive panels to be produced which provide higher milage. Such panels may also be effective at reducing vibration-generated noise that may otherwise result from a thin automotive panel.

### CROSS-REFERENCE TO RELATED APPLICATIONS

This application relates to and claims the benefit of U.S. Provisional Application No. 63/696,093 filed Sep. 18, 2024, and entitled “PANEL REINFORCEMENT WITH NOISE VIRBATION REDUCTION,” the entire disclosure of which is hereby wholly incorporated by reference.

### STATEMENT RE: FEDERALLY SPONSORED RESEARCH/DEVELOPMENT

Not Applicable

### BACKGROUND

### 1. Technical Field

The present application relates to coatings for application upon panels in order to reinforce those panels. More specifically, the present application relates to polyurethane-epoxy compositions embedded with carbon fiber which may be applied upon thin metal panels and allowed to cure thereon to improve dent resistance and reduce vibrations.

### 2. Related Art

Metal panels, used in applications ranging from automotive panels, structural pillars, building panels, aerospace structures, industrial equipment, pipelines, and much more, provide protection and structural rigidity to their associated structures. Depending on the application, it may be desirous for these panels to be strong enough to resist wear and tear from use, including bending, oil canning, and denting, while also being thin and lightweight. Unfortunately, those sets of properties tend to counteract one another, as durability typically requires additional material which would add to the weight and size of the panel. The inability to strike a balance between strength and light form-factor is particularly problematic for automotive panels used in the transportation industry, as lighter panels can dramatically increase the vehicle's mileage but since such panels are insufficiently durable and create vibrational noise while the vehicle is traveling, most persons skilled in the art don't consider them a viable option. As such, it can be seen that there is a need in the art for improved metal panels having desirable resilience while being lighter than conventionally-used metal panels.

### BRIEF SUMMARY

To solve these and other problems, reinforcing compositions are disclosed which may be applied as a thin coating upon a substrate, such as a thin panel. When cured, a reinforced panel may be produced which is lightweight, strong, and capable of reducing noise from vibrations which are typical of thin automotive panels. A method of manufacturing a reinforced substrate comprising a cured coating and a substrate may start with providing a reinforcing composition comprising a base resin binder, a reinforcing fiber, a toughener, a heat curing agent, a cure accelerating agent, a sagging resistance agent, and a reinforcing agent. The base resin binder may comprise bisphenol A epoxy resin and a bisphenol F epoxy resin having an equivalent weight ranging from 160 to 250 and ranging from 10 to 40 percent by weight of the reinforcing composition. The reinforcing fiber could range from 5 to 30 percent by weight of the reinforcing composition and may come in the form of a sheet of carbon fiber. This reinforcing fiber may ranges from 50 microns to 100 mm in length and further ranges from 5 microns to 10 microns in diameter. The toughener could comprise one or more of: epoxy adduct with carboxy terminated butyro nitrile rubber ranging from 10 to 20 percent by weight of the composition, polybutadiene-acrylic core shell ranging from 5 to 15 percent by weight of the reinforcing composition, and aliphatic/cycloaliphatic polyurethane base adduct with bisphenol A ranging from 10 to 20 percent by weight of the reinforcing composition. The heat curing agent may comprise dicyandiamide ranging from 0.5 to 5 percent by weight of the reinforcing composition and could further comprise adpic acid dihydrazide, sebasic acid dihydrazide, or both collectively ranging from 0.5 to 3 percent by weight of the reinforcing composition. The cure accelerating agent may comprise chloro toluron and range from 0.5 to 3 percent by weight of the reinforcing composition. The sagging resistance agent could comprise thixotrope fumed silica and range from 2 to 5 percent by weight of the reinforcing composition. The reinforcing agent may comprise an inorganic filler, such as wollastonite, talc, mica, precipitated calcium carbonate, barium sulfate, alumina trihydrate, or combinations thereof, and range from 5 to 20 percent by weight of the reinforcing composition.

The reinforcing composition could comprise additional components, which may be ideal for a particular application which the product to be produced will be used in. Examples include a UV-blocking agent, a corrosion resistance agent, an antifungal agent, and a flame retardant, an expanding agent, and hollow glass bubbles. The expanding agent may contribute to the coating to expanding while it cures, it could comprise thermoplastic microspheres, an azo compound or both, and be up to 4 percent by weight of the reinforcing composition. The hollow glass bubbles may be included to increase the tensile strength of the reinforced substrate being manufactured; for example, a reinforced substrate having these glass bubbles may have a tensile strength of at least 5,000 psi.

The reinforcing composition may be a thick substance having a viscosity ranging from 50,000 to 1 million centipoise but have a relatively low density ranging from 0.5 to 1.0 grams per cubic centimeter. The composition may be applied as a coating upon a substrate, such as a steel, aluminum, copper, or zinc substrate which could have a thickness of 1 mm or less. The coating may now be heated, which can be effectuated by heating the substrate having the coating thereon within an oven. The coating may be exposed to temperatures ranging from 125 to 200 degrees Celsius, more preferably temperatures ranging from 150 to 200 degrees Celsius, for a period of at least 10 minutes, at least 15 minutes, or most preferably at least an hour. The heating may cause the coating to cure, thus producing a reinforced substrate being comprised of the initial substrate and the cured coating.

Depending on the desired application of the reinforced substrate manufactured, the substrate may be sized and configured as an automotive panel, at least a portion of a structural pillar, a building panel, an aerospace structure, or a pipeline such that the reinforced substrate may be capable of being installed in its associated structure. In the event that the reinforced substrate is configured as an automotive panel, it may be associated with a door, a dashboard, a fender, a trunk lid, or a floor pan of a particular automobile. The cured coating may allow the reinforced substrate to obtain desirable strong properties which may resist denting, oil canning, and bending while also being lightweight and while being capable of reducing noise generated from vibrations that the panel may experience when traveling.

All of these embodiments are contemplated to be within the scope of this disclosure. These and other embodiments will become readily apparent to those skilled in the art form the following detailed description of the preferred embodiments, the disclosure not being limited to any particular preferred embodiment.

### DETAILED DESCRIPTION

The following disclosure encompasses various embodiments composition for reinforcing substrates, reinforced panels made from those compositions, methods of making the same which may provide a strong, durable panel suited for a variety of structural and protective applications (e.g., automotive panels), while also being lighter than conventionally employed panels and capable of reducing noise-producing vibrations. Such a panel may be manufactured by providing a substrate, such as a thin metal panel, and applying a coating of a reinforcing composition upon that substrate. That composition may be composed of a base resin binder, a reinforcing fiber, a toughener, a heat curing agent, a cure accelerating agent, a sagging resistance agent, and a reinforcing agent. The composition could further include an expanding agent, an adhesion promoter, hollow glass bubbles, a UV-blocking agent, a corrosion resistance agent, an antifungal agent, and/or a flame retardant to alter the properties of the panel to be manufactured. The substrate, having the coating thereon, may then be heated such that the coating cures. The resulting product may be a low-density panel that is durable enough to be used in place of automotive panels, building panels, and more while reducing noise generated from vibrations that the panel may experience in use.

The detailed description set forth is intended as a description of several currently contemplated embodiments and is not intended to represent the only form in which the disclosed subject matter may be developed or utilized. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

To begin, a substrate may be provided upon which a coating of a reinforcing composition may be applied. This substrate may configured and shaped similar to conventional protective and structural metal panels known and used in the art, but this substrate may be thinner than such conventional panels. In particular, the substrate may be less than 1 mm in thickness. However, thicker panels or substrates which don't come in the form of a panel could still be used in the context of this present disclosure, in which case the reinforcing coatings of this disclosure may primarily serve to strengthen a substrate as opposed to maintaining the substrate's integrity while achieving a lightweight form-factor. The substrate may comprise one or more metal materials, including, but not being limited to, steel, aluminum, copper, and zinc; specific examples of substrates in which working embodiments of reinforced panels have been manufactured from include electrogalvanized steel, hot dip galvanizing steel, cold rolled steel, and aluminum 6111 alloy.

To strengthen the selected substrate, a reinforcing composition may be provided. This reinforcing composition may contain a variety of categories of components, including a base resin binder, a reinforcing fiber, a toughener, a heat curing agent, a cure accelerating agent, a sagging resistance agent, and a reinforcing agent, and/or optional additives such as an expanding agent, an adhesion promoter, hollow glass bubbles, a UV-blocking agent, a corrosion resistance agent, an antifungal agent, and/or a flame retardant. All of these components, including specific components corresponding to preferred embodiments, will be expressed as a percentage by weight of the total weight of the reinforcing composition. It is envisaged that these ranges capture compositions which may yield various reinforced panels for use in a wide range of applications, although it is contemplated that the concentration of certain components may be adjusted to manufacture a panel which is more suitable for a particular application. For instance, adjusting the concentration of these components may modify material properties to align with industry requirements for an intended application of a panel, such as performance within a given temperature range, performance when exposed to a corrosive environment, and tolerance to extremely low temperatures (e.g., −40 to −20 degrees Celsius) or extremely high temperatures (e.g., 100 to 125 degrees Celsius).

The reinforcing composition may comprise a base resin binder ranging from 10 to 40 percent by weight of the composition. Amongst other properties, it has been found that changing the concentration of the base resin binder in this range will affect the adhesion, mechanical strength, and thermal strength of the reinforced substrate being produced. The base resin binder may be comprised of epoxy resin, such as a combination of a bisphenol A epoxy resin and a bisphenol F epoxy resin. Furthermore, mixture of epoxy resin components of the base resin binder may have an equivalent weight ranging from 160 to 250.

The reinforcing composition may further comprise a reinforcing fiber, which may come in the form of a woven sheet, ranging from 5 to 30 percent by weight of the composition. The reinforcing fiber may have a length ranging from 50 microns and 100 mm and/or a diameter ranging from 5 microns to 10 microns, but in certain preferred embodiments, it is contemplated that the reinforcing fiber may have a length ranging from 10 mm to 50 mm and/or a diameter ranging from 5 to 10 mm. The reinforcing fiber would preferably be comprised of carbon fiber; when one wishes to prioritize a lightweight formfactor for the panel to be manufactured, using carbon fiber as this component may be particularly advantageous in keeping the final product's density lower. When the composition cures upon the substrate, the process of which will be discussed later in this disclosure, this reinforcing fiber may remain embedded in the cured composition and form part of the final product.

As for the toughener, a reinforcing composition may collectively comprise tougheners ranging from 10 to 55 percent by weight of the composition. In particular, the toughener may include one or more of: epoxy adduct with carboxy terminated butyro nitrile rubber ranging from 10 to 20 percent by weight of the composition, polybutadiene-acrylic core shell ranging from 5 to 15 percent by weight of the composition, and aliphatic/cycloaliphatic polyurethane base adduct with bisphenol A ranging from 10 to 20 percent by weight of the composition. A preferred embodiment would include all of these compounds, although it is contemplated that a composition may include only the epoxy adduct with carboxy terminated butyro nitrile rubber as a toughener. The toughener may contribute to, among other things, the impact resistance, peel and fatigue resistance, and durability of the reinforced substrate produced from the reinforcing composition, and as such those properties may vary as one increases or decreases the concentration of the tougher in a composition.

A reinforcing composition may further comprise heat curing agents and/or curing accelerating agents which may aid in in the process of curing a coating of the composition applied to the coating, as will be detailed later in this disclosure. A heat curing agent could range from 0.5 to 8 percent by weight of the composition and a curing accelerating agent ranging from 0.5 to 3 percent by weight of the composition. The heat curing agent could comprise dicyandiamide ranging from 0.5 to 5 percent by weight of the composition, but in preferred embodiments the heat curing agent would comprise dicyandiamide ranging from 0.5 to 5 percent by weight of the composition and one or both of adipic acid dihyrdazide and sebasic acid dihydrazide collectively ranging from 0.5 to 3 percent by weight of the composition. The curing accelerating agent may range from 0.5 to 3 percent by weight of the composition and could comprise chloro toluron.

To lessen the coating's susceptibility of sagging, a sagging resistance agent may be included in the reinforcing composition. Thixotrope fumed silica is a preferred sagging resistance agent, and it may comprise 2 to 5 percent by weight of the composition.

A reinforcing agent may also be included in a composition and may take the form of an inorganic filler, such as wollastonite, talc, mica, precipitated calcium carbonate, barium sulfate, alumina trihydrate, or combinations thereof. The reinforcing agent may range from 5 to 20 percent by weight of the reinforcing composition. The mechanical reinforcement and/or thermal and dimensional stability of the reinforced substrate to be produced may be, at least in part, a result of the concentration of the reinforcing agent in the reinforcing composition. Additionally, the concentration of the reinforcing agent in the reinforcing composition may play a role in viscosity control and density of the composition.

Depending on the intended application of the panel to be manufactured, one may wish to include one or more optional additives. For instance, a composition may further include an adhesion promoter to permit a coating of the composition to more effectively bond to oily, metal substrates. Adhesion promoters may comprise 0.2 to 1.5 percent by weight of a composition, and an adhesion promoter may comprise, for example, a silane, a zirconate, a phosphonate, or combinations thereof. Specific examples of adhesion promoters include epoxy silane and mercapto silane. Other examples of optional additives that may improve the functionality of the product to be manufactured for a given context include a UV-blocking agent, a corrosion resistance agent, an antifungal agent, and a flame retardant. It is also contemplated that hollow glass bubbles may be included in a composition, as this may help to increase the compression strength of the product to be manufactured. In certain embodiments of panels manufactured from compositions having these hollow glass bubbles, the panel's compressive strength may be greater than 5,000 psi. The expanding agent may comprise up to 4 percent by weight of the composition, and suitable expanding agents include thermoplastic microspheres (e.g., Expancel® produced by Nouryon), azo compounds, or combinations thereof. The expanding agent may serve, at least in part, to obtain a reinforced substrate having a low-density, lightweight cured coating which also yields desirable impact resistance, toughness, thermal insultation, acoustic insulation, shrinkage resistance, and/or stress reduction.

Working embodiments of these compositions have come in the form of a light gray or black thick, viscous paste. Various embodiments have been found to have a density ranging from 0.5 to 1.0 grams per cubic centimeter and a viscosity ranging from 50,000 to 1 million centipoise. Advantageously, the volatile organic component of these compositions has been found to be less than 0.2%.

With the composition prepared and a substrate provided, the composition may be applied to one or more surfaces of the substrate. The composition may be applied to the substrate such that a coating of a thickness of at least 0.5 mm is applied to the substrate. The composition may be applied manually or with the help of machinery, such as a machine preprogrammed to apply the composition upon the substrate in a predetermined manner.

With the coating applied to the substrate, the curing process may commence by heating the coating. This may be effectuated by heating the substrate having the coating thereon in an oven; in this respect, an automotive electrocoat or pain oven could be used (which may be suitable when manufacturing an automotive panel, for instance), although any type of industrial oven suitable for heating the coating and causing it to cure may be used. The coating may be exposed to a temperature ranging from 125 to 200 degrees Celsius, preferably 150 to 200 degrees Celsius, and the coating may exposed to temperatures within this range for at least 10 minutes, at least 15 minutes, or most preferably at least 1 hour. The presence of the aforementioned heat curing agents and/or cure accelerating agents in the coating may aid in the effectiveness and speed of this curing process. The coating may expand during the coating process; in certain embodiments, the volume of the coating could expand by at least 100%.

When the coating cures, a product, comprised of the substrate and the cured coating thereon, may have been manufactured. Working embodiments of cured coatings have been found to have the following properties: an initiation temperature from differential scanning calorimetry (DSC) ranging from 125 to 160 degrees Celsius, a peak exotherm temperature from DSC ranging from 150 to 180 degrees Celsius, exotherm energy ranging from 175 to 250 joules per gram meter, and a glass transition temperature from DSC ranging from 60 to 110 degrees Celsius. Panels manufactured from such compositions have also been found to have weldability and E-coat compatibility needed to meet automotive panel original equipment manufacturer (OEM) specifications and have great sag resistance.

Various tests have been performed on working embodiments of panels comprising these cured coatings, including a three point bending test, shown in Table 1 below, tests on adhesion properties, shown in Table 2 below, tests on sound absorption, shown in Table 3 below, and miscellaneous strength tests, shown in Table 4 below.

Table 1 shows the results of a three point bending test of various panels manufactured from electrogalvanized steel substrates of varying thicknesses which had varying amounts of a reinforcing composition applied thereon as a coating. It can be appreciated that the cured coating, even when applied at 1 mm thick, dramatically increases the panel's strength.

TABLE 1
Three Point Bending Test

| | Thickness of | Thickness of | Bending Strength at |
|---|---|---|---|
| EG Steel Metal | Applied | Cured | Room Temperature |
| Thickness (mm) | Coating (mm) | Coating (mm) | (newtons) |
| 0.8 | 0 | 0 | 42 |
| 0.8 | 1 | 2.2 | 150 |
| 0.8 | 2 | 3.5 | 220 |
| 0.8 | 3 | 5.0 | 300 |
| 0.7 | 0 | 0 | 35 |
| 0.7 | 1 | 2.2 | 140 |
| 0.7 | 2 | 3.5 | 200 |
| 0.7 | 3 | 5.0 | 260 |
| 0.6 | 0 | 0 | 29 |
| 0.6 | 1 | 2.2 | 135 |
| 0.6 | 2 | 3.5 | 195 |
| 0.6 | 3 | 5.0 | 240 |

The adhesive capabilities of the coatings of this present disclosure were tested by applying a coating of the reinforcing composition between two electrogalvanized steel substrates and curing the coating such that the two substrates were held together by the cured coating. The force needed to separate the two substrates, according to a lap shear test and peel test performed at various temperatures, is detailed in table 2 below.

TABLE 2
Adhesion Properties
LAP SHEAR STENGTH TEST

| Temperature | | |
|---|---|---|
| (degrees Celsius) | Force Needed for Cohesive Failure (megapascals) | |
| Room temperature | 12 | MPa |
| −40 | 15 | MPa |
| 82 | 10 | MPa |

PEEL STRENGTH TEST

| Temperature | Force Needed for Cohesive Failure | |
|---|---|---|
| (degrees Celsius) | (newtons per meter) | |
| Room temperature | 10,000 | N/m |
| −40 | 12,000 | N/m |
| 82 | 8,500 | N/m |

The sound-absorbing capabilities of these reinforced panels were tested by measuring the Oberst Bar loss factor from 200 to 440 Hz. These tests were performed on a panel comprised of electrogalvanized steel having a cured coating thereon.

TABLE 3
Sound Absorption

| Temperature | |
|---|---|
| (degrees Celsius) | Oberst Bar loss factor |
| −20 | 0.03-0.04 |
| −10 | 0.05-0.06 |
| 25 | 0.1-0.25 |
| 40 | 0.08-0.22 |
| 50 | 0.04-0.15 |

The results shown in table 4 show various tests relating to the strength of panels made according to this present disclosure. Various working embodiments were tested, including a variety of substrates listed in the first row, columns 3-6.

TABLE 4
Various Strength Tests

| | Temperature, | | | | | | | | |
|---|---|---|---|---|---|---|---|---|---|
| | Thickness of | | | | | | | | |
| | Applied | | | Hot Dip | | | | | |
| | Coating (when | Electrogalvanized | | Galvanizing | | Cold Rolled | | Aluminum | |
| TEST | relevant) | Steel Substrate | | Steel Substrate | | Steel | | 6111 Alloy | |
| Lap Sheer | Room | 14 | MPa | 14 | MPa | 18 | MPa | 16 | MPa |
| Strength | Temperature | | | | | | | | |
| (megapascals) | | | | | | | | | |
| | 82 | 12 | MPa | 12 | MPa | 16 | MPa | 14 | MPa |
| | −40 | 17 | MPa | 17 | MPa | 22 | MPa | 18 | MPa |
| Peel Strength | Room | 10,000 | N/m | 10,000 | N/m | 11,000 | N/m | 9,000 | N/m |
| (newtons per | Temperature | | | | | | | | |
| meter) | | | | | | | | | |
| | 82 | 8,500 | N/m | 8,000 | N/m | 9,000 | N/m | 8,000 | N/m |
| | −40 | 12,000 | N/m | 11,500 | N/m | 12,000 | N/m | 10,000 | N/m |
| Three-Point | Room | 150N | | 150N | | 130N | | 125N | |
| Flexural | Temperature, 1 | | | | | | | | |
| Strength for a | mm of uncured | | | | | | | | |
| 0.8 mm thick | coating applied | | | | | | | | |
| substrate | | | | | | | | | |
| (newtons) | | | | | | | | | |
| | Room | 220N | | 220N | | 200N | | 190N | |
| | Temperature, 2 | | | | | | | | |
| | mm of uncured | | | | | | | | |
| | coating applied | | | | | | | | |
| | Room | 310N | | 300N | | 280N | | 230N | |
| | Temperature, 3 | | | | | | | | |
| | mm of uncured | | | | | | | | |
| | coating applied | | | | | | | | |
| Lap Sheer | Room | 12 | MPa | 11.5 | MPa | 9.5 | MPa | 15 | MPa |
| Strength after | Temperature | | | | | | | | |
| Arizona | | | | | | | | | |
| Proving | | | | | | | | | |
| Grounds | | | | | | | | | |
| Exposure | | | | | | | | | |
| (APGE) | | | | | | | | | |
| Corrosion Test | | | | | | | | | |
| (megapascals) | | | | | | | | | |

It is contemplated that a substrate may be sized and configured to be used in a particular application such that the product to be manufactured may be capable of being installed in a structure associated with that application. For instance, the substrate may be sized and configured to come in the form of a panel. The substrate may be sized/configured in this manner prior to or after the coating has been applied to the substrate, although preferably this process will take place before the coating is applied to the substrate. A panel manufactured via the methods from this present disclosure may be ideally suited for use as an automotive panel, such as a panel associated with a door, a dashboard, a fender, a trunk lid, or a floor pan of a vehicle, including those associated with trucks. The lightweight, strong, and sound-absorbing capabilities of these panels make them ideal for use in the transportation industry to increase milage while still being resistant to wear and tear such as bending, oil canning, and denting. Other applications, however, are contemplated for these panels, including structural pillars, building panels (which may be used in place of conventional steel and aluminum building panels), aerospace panels, and pipelines; in the case of pipelines, a coatings may be applied to both internal and external surfaces of a pipeline substrate, as this may provide reinforcement and corrosion resistance to both sides of the pipeline.

The above description is given by way of example, and not limitation. Given the above disclosure, one skilled in the art could devise variations that are within the scope and spirit of this disclosure. Further, the various features of the embodiments disclosed herein can be used alone, or in varying combinations with each other and are not intended to be limited to the specific combination described herein. Thus, the scope of the claims is not to be limited by the illustrated embodiments. Additional modifications and improvements of the present disclosure may also be apparent to those of ordinary skill in the art. Thus, the particular combination of parts and steps described and illustrated herein is intended to represent only certain embodiments of the present subject matter and is not intended to serve as limitations of alternative devices and methods within the spirit and scope of this disclosure.

What is claimed is:

1. A method of manufacturing a reinforced substrate comprising a cured coating and a substrate, the method comprising the steps of:
providing a reinforcing composition comprising:
a base resin binder comprising bisphenol A epoxy resin and a bisphenol F epoxy resin, the base resin binder having an equivalent weight ranging from 160 to 250, the base resin binder ranging from 10 to 40 percent by weight of the reinforcing composition;
a reinforcing fiber comprising a sheet of carbon fiber, the reinforcing fiber ranging from 5 to 30 percent by weight of the reinforcing composition;
a toughener comprising:
epoxy adduct with carboxy terminated butyro nitrile rubber, the epoxy adduct with carboxy terminated butyro nitrile rubber ranging from 10 to 20 percent by weight of the composition;
a heat curing agent comprising:
dicyandiamide, the dicyandiamide ranging from 0.5 to 5 percent by weight of the reinforcing composition;
a cure accelerating agent comprising chloro toluron, the cure accelerating agent ranging from 0.5 to 3 percent by weight of the reinforcing composition;
a sagging resistance agent comprising thixotrope fumed silica, the sagging resistance agent ranging from 2 to 5 percent by weight of the reinforcing composition; and
a reinforcing agent comprising an inorganic filler, the reinforcing agent ranging from 5 to 20 percent by weight of the reinforcing composition;
applying a coating of the reinforcing composition upon the substrate; and
heating the coating such that the coating cures.

2. The reinforced substrate manufactured by the method of claim 1.

3. The method of claim 1, wherein the sheet of carbon fiber ranges from 50 microns to 100 mm in length and further ranges from 5 microns to 10 microns in diameter.

4. The method of claim 1, wherein the toughener further comprises:
polybutadiene-acrylic core shell, the polybutadiene-acrylic core shell ranging from 5 to 15 percent by weight of the reinforcing composition; and
aliphatic/cycloaliphatic polyurethane base adduct with bisphenol A, the aliphatic/cycloaliphatic polyurethane base adduct with bisphenol A ranging from 10 to 20 percent by weight of the reinforcing composition.

5. The method of claim 1, wherein the heat curing agent further comprises:
adpic acid dihydrazide, sebasic acid dihydrazide, or both, the adpic acid dihydrazide and sebasic acid dihydrazide collectively ranging from 0.5 to 3 percent by weight of the reinforcing composition.

6. The method of claim 1, wherein the inorganic filler comprises wollastonite, talc, mica, precipitated calcium carbonate, barium sulfate, alumina trihydrate, or combinations thereof.

7. The method of claim 1, wherein the reinforcing composition further comprises:
an expanding agent comprising thermoplastic microspheres, an azo compound, or both, the expanding agent being up to 4 percent by weight of the reinforcing composition.

8. The method of claim 1, wherein the composition further comprises:
hollow glass bubbles.

9. The method of claim 1, wherein the composition further comprises one or more of: a UV-blocking agent, a corrosion resistance agent, an antifungal agent, and a flame retardant.

10. The method of claim 1, wherein the reinforcing composition has a density ranging from 0.5 to 1.0 grams per cubic centimeter.

11. The method of claim 1, wherein the substrate comprises steel, aluminum, copper, zinc, or combinations thereof.

12. The method of claim 1, wherein the substrate has a thickness of 1 mm or less.

13. The method of claim 1, wherein said step of heating the coating comprises exposing the coating to a temperature ranging from 125 to 200 degrees Celsius.

14. The method of claim 13, wherein said step of heating the coating further comprises keeping the coating exposed to temperatures within the range of 125 to 200 degrees Celsius for at least 10 minutes.

15. The method of claim 1, wherein the method further comprises a step of:
sizing and configuring the substrate as an automotive panel, at least a portion of a structural pillar, a building panel, an aerospace structure, or a pipeline.

16. An automobile comprising, the reinforced substrate manufactured by the method of claim 15, the reinforced substrate comprising the automotive panel, the automotive panel being associated with a door, a dashboard, a fender, a trunk lid, or a floor pan of the automobile.

17. A reinforcing composition for reinforcing a substrate, the reinforcing composition comprising:
a base resin binder comprising bisphenol A epoxy resin and a bisphenol F epoxy resin, the base resin binder having an equivalent weight ranging from 160 to 250, the base resin binder ranging from 10 to 40 percent by weight of the reinforcing composition;
a reinforcing fiber comprising a sheet of carbon fiber, the reinforcing fiber ranging from 5 to 30 percent by weight of the reinforcing composition;
a toughener comprising:
epoxy adduct with carboxy terminated butyro nitrile rubber, the epoxy adduct with carboxy terminated butyro nitrile rubber ranging from 10 to 20 percent by weight of the composition;
a heat curing agent comprising:
dicyandiamide, the dicyandiamide ranging from 0.5 to 5 percent by weight of the reinforcing composition;
a cure accelerating agent comprising chloro toluron, the cure accelerating agent ranging from 0.5 to 3 percent by weight of the reinforcing composition;
a sagging resistance agent comprising thixotrope fumed silica, the sagging resistance agent ranging from 2 to 5 percent by weight of the reinforcing composition; and
a reinforcing agent comprising an inorganic filler, the reinforcing agent ranging from 5 to 20 percent by weight of the reinforcing composition.

18. The reinforcing composition of claim 17, wherein the composition further comprises:
an expanding agent comprising thermoplastic microspheres, an azo compound, or both, the expanding agent being up to 4 percent by weight of the reinforcing composition; wherein the toughener further comprises:
polybutadiene-acrylic core shell, the polybutadiene-acrylic core shell ranging from 5 to 15 percent by weight of the reinforcing composition; and
aliphatic/cycloaliphatic polyurethane base adduct with bisphenol A, the aliphatic/cycloaliphatic polyurethane base adduct with bisphenol A ranging from 10 to 20 percent by weight of the reinforcing composition; and
wherein the heat curing agent further comprises:
adpic acid dihydrazide, sebasic acid dihydrazide, or both, the adpic acid dihydrazide and sebasic acid dihydrazide collectively ranging from 0.5 to 3 percent by weight of the reinforcing composition.

19. The reinforcing composition of claim 17, wherein the reinforcing composition has a density ranging from 0.5 to 1.0 grams per cubic centimeter.

20. The reinforcing composition of claim 17, wherein the reinforcing composition has a viscosity ranging from 50,000 to 1 million centipoise.
